(19) United States
(12) Patent Application Publication
(10) Pub. No.: US 2007/0170799 A1
(43) Pub. Date: Jul. 26, 2007

(54) Snyder pulley-gear system powered by permanent magnets

(76) Inventor: Carl R. Snyder, Pembroke Pines, FL (US)

Correspondence Address: CARL R. SNYDER, 19420 SW 2 ST, PEMBROKE PINES, FL, 33029, US

(21) Appl. No.: 11/329,337

(22) Filed: Jan. 10, 2006

(51) Int. Cl. F03G 3/00

(52) U.S. Cl. 310/103; 185/27

(57) ABSTRACT

Snyder Pulley-Gear System Powered by Permanent Magnets is a design to configure permanent magnets, a pulley, and a counter-weight such that they form a system that can produce a positive work output that can be used to drive gears. The core idea of this design is the specific concept of using permanent magnets, pulleys, and counterweights together to produce a system that can drive gears. The permanent magnets can be replaced with electromagnets in the design or a mix of permanent magnets and electromagnets can be used. The concept uses a permanent magnet and a non-magnetic counterweight on a pulley. The counterweight is at least 10 percent heavier than the pulley's magnet. A moving permanent magnet at ground level is then moved underneath the pulley's magnet and used to attract the magnet side of the pulley. That drives the gears in the system and pulls the counter-weight up. It also drives a magnetic shield to move between the two magnets before they are able to connect. With the magnetic shield in place, the counter-weight pulls the magnet on the pulley back up. At the same time, the moving magnet slides away and is no longer underneath the pulley's magnet. As the pulley's magnet moves up, the magnetic shield returns to its starting point. The process then starts again. The ground level permanent magnet can be replaced with an electromagnet if desired. As long as the magnets are properly shaped bar magnets, with their length and height much greater than their width, then the amount of pulley movement is substantial. The width of the magnets should be less than the length of pulley cable movement during the magnets' attraction. Keeping the magnets shaped properly also ensures that a sufficient magnet shield can slide into place during the magnets' attraction. The work output possible for the system is at a minimum: WORK OUTPUT=(MASS OF MAGNET A)(0.30)(9.8 meters/second squared)(TIME). Only industry standard ceramic magnets are required to produce such a work output.

### INTRODUCTION

The Snyder Pulley-Gear System Powered by Permanent Magnets is a design to configure permanent magnets, a pulley, and a counter-weight such that they form a system that can produce a positive work output that can be used to drive gears. Inventor is Mr. Carl R. Snyder, 19420 SW 2 St, Pembroke Pines, Fla. 33029.

### BACKGROUND

This invention uses principles primarily from the fields of mechanical engineering, physics, electrical engineering, and materials engineering. Purpose of the invention is to solve the problem of driving gears without having to continually refuel the system. Permanent magnets need no refueling, don't rely on the presence of the sun, water, or wind, and don't emit harmful radiation.

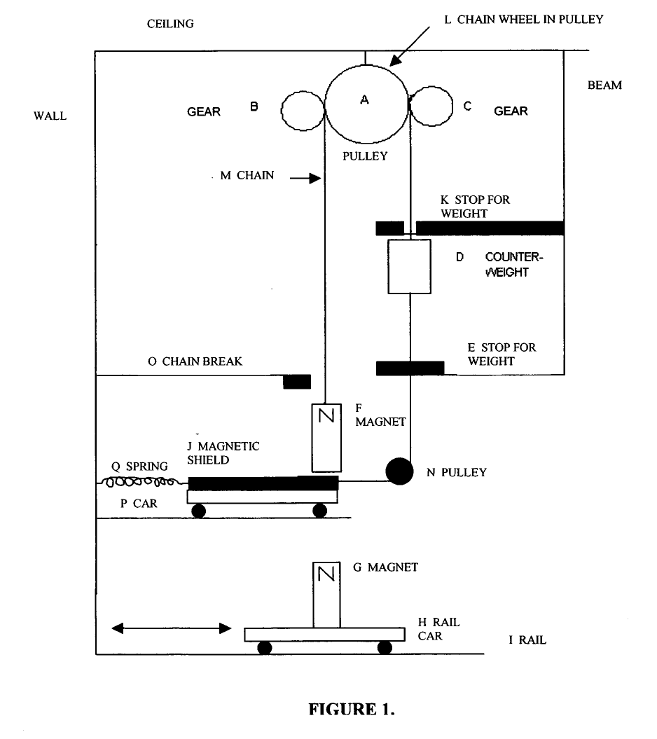

### DESCRIPTION OF FIG. 1

The system's work output is initiated by moving Magnet G out from underneath Magnetic Shield J and into position directly under Magnet F. Rail Car H is powered by an electric motor that receives external power. This begins magnetic attraction between Magnet F and Magnet G. Magnet G stays fixed in its rail car while Magnet F is able to move towards Magnet G. Magnet F and Magnet G are made of the same ceramic material, have the same shape, and have the same weight.

As Magnet F moves towards Magnet G, it pulls the Counter-weight D up and it pulls the Magnetic Shield J between the two magnets. This keeps the acceleration of Magnet F towards Magnet G controlled. It also prevents the magnets from connecting. The Stop K for the counter-weight also prevents the magnets from connecting as does the Chain Break O. The acceleration of Magnet F toward Magnet G is also limited by the opposing forces from the weight of the counter-weight, resistance from Gear B and Gear C, and the tension in Spring Q.

The movement of Magnet F turns Pulley A which also turns Chain Wheel L in the pulley. Chain Wheel L turns Gear B and Gear C. Each gear provides equal resistance to the chain wheel.

Once Magnetic Shield J has been pulled into place, Rail Car H moves Magnet G back to its starting position. Again, the movement of Rail Car H is powered by an electric motor that receives external power. With Magnet G and Magnet F no longer attracting each other, the Counter-Weight D pulls Magnet F back up to its starting position. Counter-Weight D is 110% of the weight of Magnet F. As Magnet F moves back up, Spring Q is able to pull Magnetic Shield J back into its starting position.

The process is repeated again by moving Magnet G back underneath Magnet F.

### DETAILED DESCRIPTION

The Snyder Pulley-Gear System Powered by Permanent Magnets is a system that can drive gears using magnets as the source of power. Industry standard ceramic magnets can be used in the system. In addition, a mix of permanent magnets and electromagnets can also be used. Each of the magnets must be shaped so that the height and length are much larger than the width.

(Refer to FIG. 1.) The system's work output is initiated by moving Magnet G out from underneath Magnetic Shield J and into position directly under Magnet F. Rail Car H is powered by an electric motor that receives external power. This begins magnetic attraction between Magnet F and Magnet G. Magnet G stays fixed in its rail car while Magnet F is able to move towards Magnet G. Magnet F and Magnet G are made of the same ceramic material, have the same shape, and have the same weight.

As Magnet F moves towards Magnet G, it pulls the Counter-weight D up and it pulls the Magnetic Shield J between the two magnets. This keeps the acceleration of Magnet F towards Magnet G controlled. It also prevents the magnets from connecting. The Stop K for the counter-weight also prevents the magnets from connecting as does the Chain Break O. The acceleration of Magnet F toward Magnet G is also limited by the opposing forces from the weight of the counter-weight, resistance from Gear B and Gear C, and the tension in Spring Q.

The movement of Magnet F turns Pulley A which also turns Chain Wheel L in the pulley. Chain Wheel L turns Gear B and Gear C. Each gear provides equal resistance to the chain wheel.

The width of the magnets is kept smaller than the movement of Chain M (movement as Magnet F moves towards Magnet G). This ensures that Magnetic Shield J can move completely underneath Magnet F, limit the movement of Magnet F, and make it easier to move Magnet G back to its starting position. The length of the magnets used, the length of the magnetic shield used, and the number of pulleys and gears used can be scaled to meet a user's requirements for work output. The work output possible for the system is at a minimum: WORK OUTPUT=(MASS OF MAGNET A)(0.30)(9.8 meters/second squared)(TIME). Again, this assumes industry standard ceramic magnets are used. As magnetic materials continue to advance, the work output of this system will increase.

Once Magnetic Shield J has been pulled into place, Rail Car H moves Magnet G back to its starting position. Again, the movement of Rail Car H is powered by an electric motor that receives external power. With Magnet G and Magnet F no longer attracting each other, the Counter-Weight D pulls Magnet F back up to its starting position. Counter-Weight D is 110% of the weight of Magnet F. As Magnet F moves back up, Spring Q is able to pull Magnetic Shield J back into its starting position.

The process is repeated again by moving Magnet G back underneath Magnet F.

Magnet G can be replaced with an electromagnet in order to more easily control the movement of Magnet F. This would also negate needing Rail Car H and the electromagnet could remain in a fixed position. An external power source would be required to provide such an electromagnet the current it would need. However, the work output for such a system would still be positive.

1. This patent is to secure rights to the design of this system which includes the combined use of permanent magnets, a pulley, and a counter-weight to produce positive work output. Any variation of the combined use of permanent magnets with a pulley or pulleys, and a counterweight or counterweights, should be protected by this patent. The core idea of this design is the specific concept of using permanent magnets, pulleys, and counterweights together to produce a system that can drive gears. In addition, replacing permanent magnets with electromagnets in the design should also be protected by this patent.
